(19) United States
(12) Patent Application Publication
(10) Pub. No.: US 2009/0127306 A1
(43) Pub. Date: May 21, 2009

(54) Tailgating System

(76) Inventors: Kevin G. Mims, Conroe, TX (US); Michael G. Mims, Conroe, TX (US)

Correspondence Address: WINSTEAD PC, P.O. BOX 50784, DALLAS, TX, 75201, US

(21) Appl. No.: 12/271,410

(22) Filed: Nov. 14, 2008

Related U.S. Application Data
(60) Provisional application No. 60/987,972, filed on Nov. 14, 2007.

(51) Int. Cl. B60R 9/00; A47B 81/06

(52) U.S. Cl. 224/404; 312/7.2; 29/428

(57) ABSTRACT

A portable unit includes a body having a bottom panel, a wall extending upward from the bottom panel and surrounding at least a portion of the bottom panel to define an interior area; a lid moveably connected with the body, the lid moveable between an open position and a closed position; and a video monitor connected with the lid, the video monitor moveable between an open and a closed position. In the closed position the video monitor may be oriented substantially parallel to the lid. The video monitor may be connected to one or more electronic devices for providing live broadcast or recorded video.

### RELATED APPLICATIONS

This application claims the benefit of U.S. Provisional Patent Application No. 60/987,972 filed Nov. 14, 2007.

### TECHNICAL FIELD

The present invention relates in general to recreational activities and more specifically to modular unit for tailgating type activities.

### BACKGROUND

At sporting events, groups of people may gather before, during, or after the event to have a tailgate party, often referred to as tailgating. Fans of the teams may gather in the parking lot of a stadium to grill food, have drinks, and socialize with other fans. The fans may want to bring food, drinks, A/V equipment, chairs, grills, and various other things. For instance, people may tow grills and may bring food, kegs of beer, chairs, and other things in trucks or other vehicles to a sporting event. However, they may be limited by the size of their vehicles and may require a trailer for additional space. Further, pickup trucks, which are often used for tailgating, have open beds which are exposed to weather conditions.

### SUMMARY

One embodiment of a tailgating unit includes a body having a bottom panel, a wall extending upward from the bottom panel and surrounding at least a portion of the bottom panel to define an interior area; a lid moveably connected with the body, the lid moveable between an open position and a closed position; and a fluid dispensing tap integrated with the unit and connectable with a fluid source. The lid may be connected to the body by an actuator. The actuator may be, without being limited to a mechanical actuator, a hydraulic actuator, a pneumatic actuator, or an electro-mechanical actuator. The fluid provided at the fluid source may be for consumption and/or for other purposes such as cleaning and the like. The reservoir source may be integrated with the body. The reservoir may be provided in the wall. In some embodiments the fluid source may be a portable reservoir such as a keg. The unit may include a video monitor such as, but not limited to a television. The video monitor may be connected to the body and in some embodiments it is moveably connected with the lid.

One embodiment of a portable unit includes a body having a bottom panel, a wall extending upward from the bottom panel and surrounding at least a portion of the bottom panel to define an interior area; a lid moveably connected with the body, the lid moveable between an open position and a closed position; and a video monitor connected with the lid, the video monitor moveable between an open and a closed position. In the closed position the video monitor may be oriented substantially parallel to the lid. The video monitor may be connected to one or more electronic devices for providing live broadcast or recorded video.

An embodiment of a method for removing a tailgating unit from a vehicle includes the steps of positioning a rack above the tailgating unit that is positioned on the vehicle, the tailgating unit comprising a body having a bottom panel, a wall extending up from the bottom panel and surrounding at least a portion of the bottom panel, and a lid member moveably connected to the body between an open and a closed position; tethering the open lid to a rack positioned above the tailgating unit; and actuating the lid from the open position to the closed position causing the body to be raised to the lid and away from the vehicle.

The foregoing has outlined some of the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an perspective view of an embodiment of a tailgating unit of the present invention adapted for connection with a pickup truck;

FIG. 2 is a plan view of an embodiment of a tailgating unit;

FIG. 3 is an end view of an embodiment of a tailgating unit in a closed position;

FIG. 4 is an end view of an embodiment of a tailgating unit in an open position; and

FIGS. 5 and 6 are end elevation views of an embodiment of a tailgating unit illustrating and embodiment of a method of connecting or disconnecting a tailgating unit with a vehicle.

### DETAILED DESCRIPTION

Refer now to the drawings wherein depicted elements are not necessarily shown to scale and wherein like or similar elements are designated by the same reference numeral through the several views.

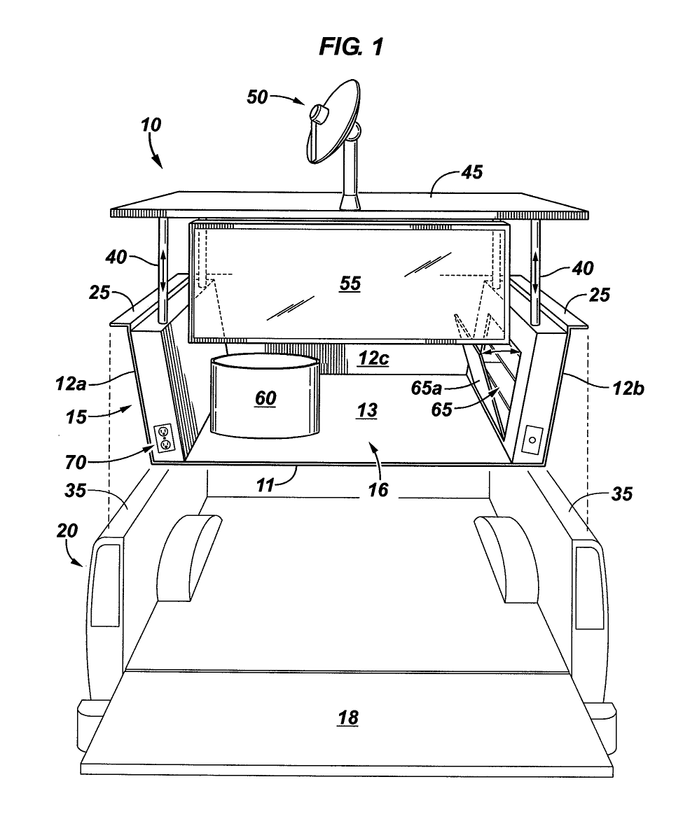

FIG. 1 illustrates an embodiment of a tailgating unit, generally denoted by the numeral 10, adapted for use with a vehicle 20. While embodiments described herein may be directed towards a system adapted for a truck, the modular tailgating system is in no way limited to use with a vehicle or with a particular type of vehicle. For example, the tailgating unit can be adapted for use in a flatbed truck, van, SUV, car, or any other suitable vehicle including vehicles that travel on other surfaces such as boats or the like. Unit 10 may be an independent unit positioned and setup for use for example on the ground.

Unit 10 includes a body 15 having a bottom panel 11 and at least one wall 12 that extends upward from bottom 11 and surrounds all or a part of bottom 11 to define an interior area 13. In the illustrated embodiment, body 15 is constructed of a fiberglass material, but may be constructed of any suitable material including plastic and metal. In the illustrated embodiment, interior area 13 is substantially rectangular and surrounded by opposing sidewalls 12a, 12b, and cross-wall 12c to form an opening 16 opposite from cross-wall 12c. Sidewalls 12a, 12b, and cross-wall 12c may be portions of a substantially unitary wall 12 or individual wall segments.

A door 18 may be provided to selectively close opening 16. In the illustrated embodiment, door 18 is provided by the tailgate of truck 20. In other embodiments, door 18 is separate from the tailgate (if any) and is movably positioned in opening 16. In these embodiments, door 18 may be removed from covering opening 16 and removed from physical connection with body 15 or may be maintained in physical connection to body 15.

In the illustrated embodiment, shoulders 25 that extend outward from sidewalls 12a, 12b of body 15 are provided for mounting on side rails 35 of vehicle 20 in a manner to support body 15. Body 15 may provide taps for distributing beverages, such as water, beer, and any other suitable fluids. Unit 10 may also include electronic devices such as, and without limitation, a satellite dish 50, a monitor 55 such as a television, audio and video receivers and the like. Monitor 55 may have an integrated receiver, be connected to an independent receiver, and/or connected to a source that provides a recorded visual signal to monitor 55. In the illustrated embodiment, monitor 55 is a flat panel monitor. For purposes of description, monitor 55 will also be referred to herein as a video monitor.

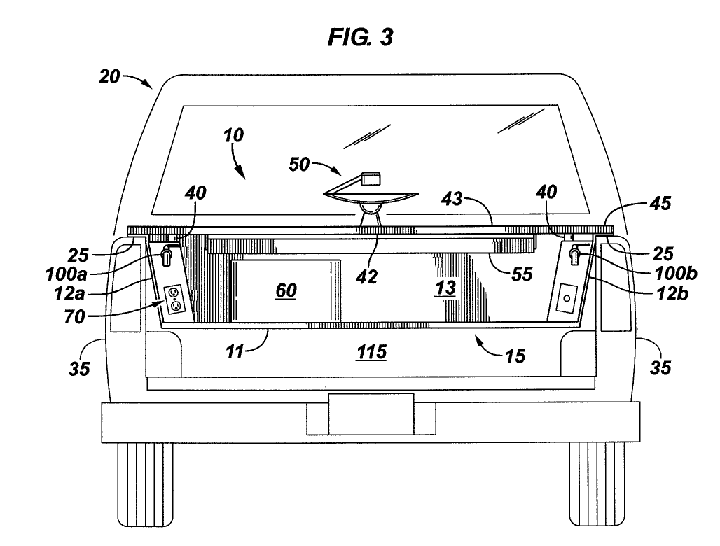

Unit 10 includes a lid 45 moveably disposed with body 15. In the illustrated embodiment, actuators 40 are connected between body 15 and lid 45 to move the lid between a closed position and an open position. In the closed position (FIG. 3), lid 45 is substantially in contact with wall 12 to enclose, at least from above, interior area 13. In the open position, lid 45 is moved away from the body, relative to the closed position, to increase the volume of interior area 13. In the illustrated embodiment, lid 45 is moved to an open position in which it is oriented substantially parallel to bottom panel 11. In some embodiments, lid 45 is raised in a hinged manner and is oriented in a non-parallel plane relative to bottom 11. Actuators 40 may be for example, and without limitation, mechanical actuators, hydraulic actuators, pneumatic actuators, electro-mechanical actuators, or the like. While the illustrated embodiments illustrate multiple actuators 40, other embodiments may utilize one actuator or any suitable number of actuators.

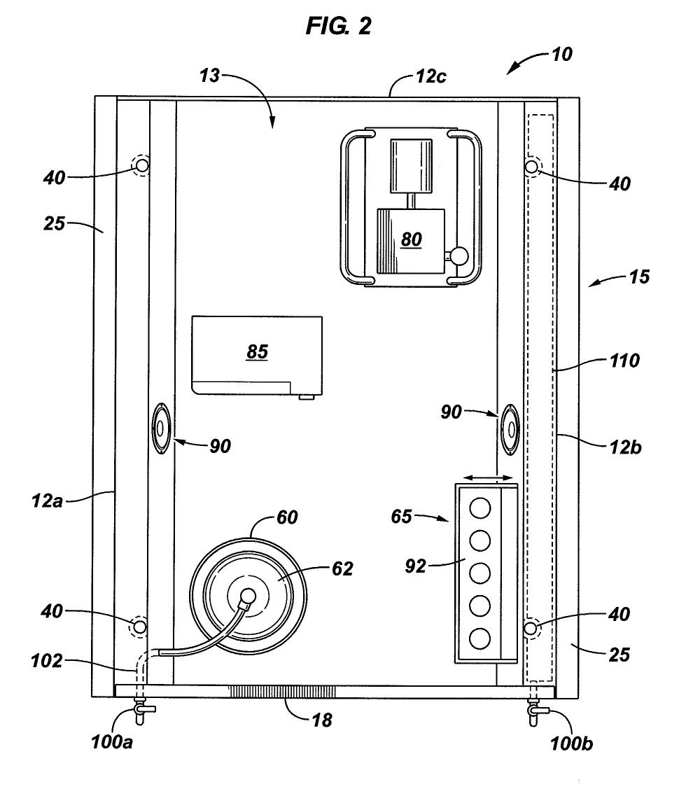

FIG. 2 is a top view of an embodiment of tailgating unit 10 with the lid removed to reveal the interior area 13. Moveable door 18 is illustrated in this embodiment as connected directly with body 15. Various devices may be stored, transported and/or physically connected or integrated with body 15. For example, an electrical power source 80, a microwave 85, speakers 90, and a well 60 are illustrated in this embodiment.

Unit 10 is adapted for use with one or more electronic devices and in most embodiments includes one or more electronic devices physically carried by body 15. In some embodiments, body 15 includes electrical and/or audio video wiring (not specifically shown) that is routed in structure forming body 15 for powering electronic devices. Body 15 is adapted in these embodiments for connecting with an electric power source 80. Power source 80 may include without limitation generators, batteries, as well as local electric sources. Local electric sources include transmission lines and the like to which connection is provided at setup site.

Power source 80 may be electrically connected to all or some of the related electrical devices directly, through wiring integral with body 15, and/or through an electrical outlet 70 integral with body 15. Electrical devices are identified generally by the numeral 92 and in some specific instances by particular reference numbers for purposes of description. Electrical devices 92 may include, without limitation, communication devices such as antennas and/or satellite dish 50, cooking devices such as a microwave 85, audio and/or visual devices, television 55, speakers 90, FM and/or AM receivers, computers, processors, DVD players, tape players, VHS players and the like.

Storage spaces 65 may be disposed in body 15. For example, a cabinet 65 may be integrated with a wall 12 (see FIG. 1 and FIG. 2). Storage spaces 65 may be provided in various portions of body 15 and in various manners. For example, in FIG. 1 a cabinet 65 is illustrated formed in wall 12 and accessed by a door 65a. In the embodiment illustrated in FIG. 2, cabinet 65 folds out from wall 12 to provide access, for example to a satellite receiver 92. In other embodiments, one or more cabinets 65 may be integrated in body 15 for general storage and for additional electronic devices.

In some embodiments, one or more taps 100 may be provided for dispensing fluids. In the illustrated embodiment, a first tap 100a is shown disposed at wall 12a, and integrated with body 15. A conduit 102 fluidly connects tap 100a with a fluid reservoir. In this embodiment, the reservoir is a portable reservoir such as a keg that is disposed in a well 60. Well 60 may be removably positioned in body 15 or secured in body 15. A second tap 100b is illustrated in this embodiment disposed at wall 12b. In this embodiment, tap 100b is in fluid connection with a reservoir 110, or tank, provided in wall 12b. In this example, tank 110 contains water. It is further identified that storage spaces 65 or the like can be provided in walls 12 for refrigeration. For example, a storage space 65 may be insulated and carry ice. In some embodiments, storage space 65 comprises an electric refrigeration unit. Conduits 102, in some embodiments, pass through ice or other cooling elements to cool the fluid being dispensed. It is noted that taps 100 may include, without limitations, various type valves and faucets for dispensing fluid. Taps 100 may be in a fixed position relative to body 15 or moveable relative to body 15. In one example, a tap includes a length of conduit, which may be coiled for example, having a valve at a terminal end. The tap may then be extended away from body 15.

FIG. 3 is an end view of and embodiment of a tailgating unit 10. In this embodiment, body 15 rests on side rails 35 of truck 20 leaving a recess 115 between the bottom of body 15 and the bed of truck 20. Recess 115 provides space for storing additional items, such as folding chairs and various other items. Lid 45 is shown in the closed position. The moveable door or wall is not shown in this illustration to reveal interior area 13 and recess 115.

In the illustrated embodiment of FIGS. 1, 3 and 4, lid 45 is coupled to body 15 by actuators 40 for moving lid 45 between the closed and open positions. Various electronic components of unit 10 may be attached to lid 45. In some embodiments, monitor 55 is moveably connected to a bottom side or surface 42 of lid 45. In the closed position, monitor 55 may be moved to a position substantially parallel to lid 45 (FIG. 3). In some embodiments, satellite dish 50 is moveably connected to a top surface 43 of lid 45. In the closed position, satellite dish 50 may be moved down toward top 43 of lid 45 to reduce its profile for traveling. Satellite dish 50 and monitor 55 may be attached to actuators that move dish 50 and monitor 55 relative body 15 and/or lid 45.

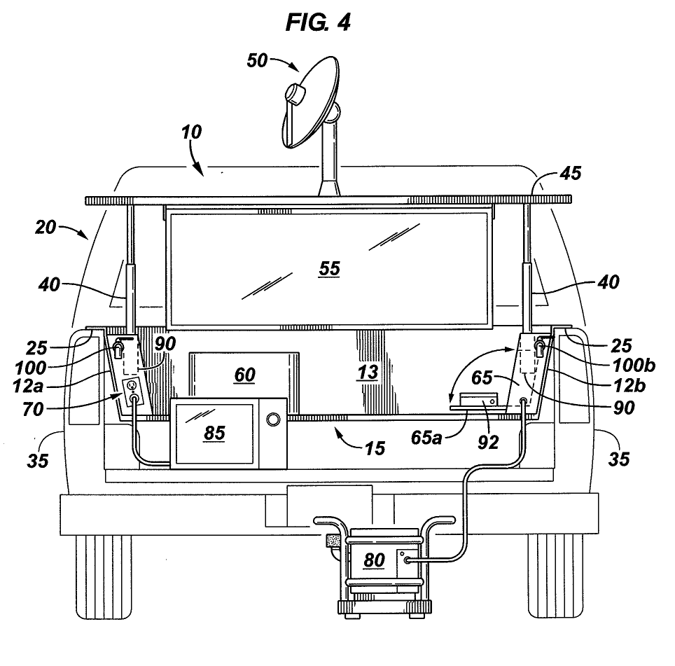

FIG. 4 is an end view an embodiment of tailgating unit 10 in the open position. In the open position, lid 45 is moved above body 15 by linear actuators 40. Satellite dish 50 is shown in an upright position. Monitor 55 is shown in the open position. Cabinets 65 may be utilized to house electronic equipment 92, such as DVD players, stereo receivers, CD players, and the like. An electricity generator 80 is shown positioned exterior of body 15 and illustrated as electrically connected to body 15 for supplying electricity to various electrical devices. A microwave 85 is shown positioned on the tailgate of vehicle 20. In some embodiments, speakers 90 are integrated into body 15 and may be extended away from body 15 for use

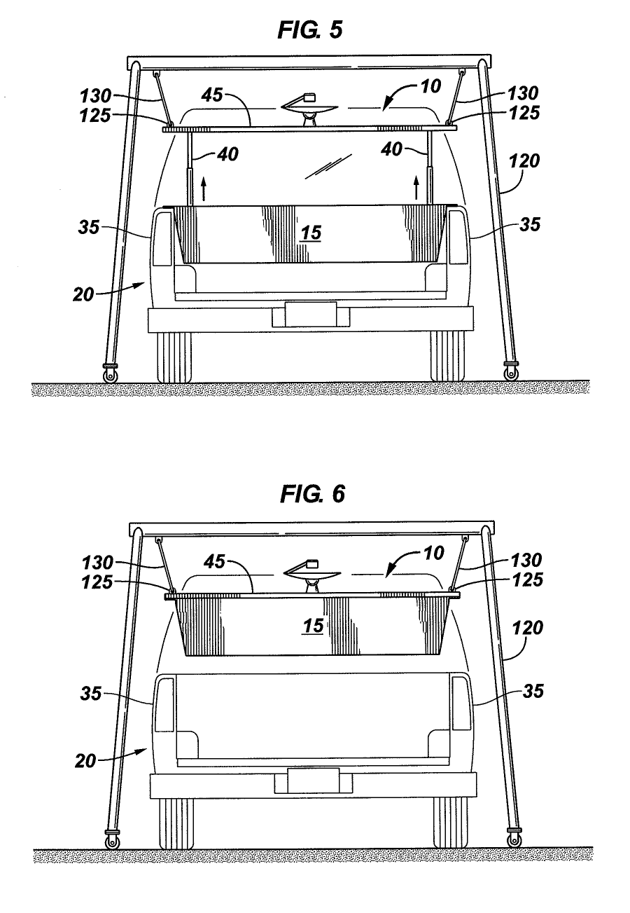

FIGS. 5 and 6 illustrate an embodiment of a method of removing a unit from or installing a unit 10 with a vehicle 20. The method will be described with reference to removing unit 10 from a vehicle 10, which is a pickup truck in the illustrated embodiment. Lid 45 may include several lifting attachments 125, for example eyelets provided at the corners of lid 45. Lid 45 is actuated to the open position and tethers 130 are connect between lid 45 and rack 120. Once unit 10 is secured to rack 120, lid 45 may be actuated to the closed position causing body 15 to be lifted up to lid 45 and away from vehicle 20.

The modular tailgating unit provides several features and equipment that may be desired for a tailgating party. While several embodiments discuss features for tailgating parties, the tailgating unit may also be utilized for other purposes, such as camping, road trips, and the like. Features and equipment provided may be modified for the particular purpose that the modular tailgating unit is to be utilized.

From the foregoing detailed description of specific embodiments of the invention, it should be apparent that an apparatus that is novel and unobvious has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A tailgating unit comprising:
a body having a bottom panel, a wall extending upward from the bottom panel and surrounding at least a portion of the bottom panel to define an interior area;
a lid moveably connected with the body, the lid moveable between an open position and a closed position; and
a fluid dispensing tap integrated with the unit and connectable with a fluid source.

2. The unit of claim 1, wherein lid is connected to the body by an actuator.

3. The unit of claim 2, wherein the actuator is selected from a group consisting of mechanical actuators, hydraulic actuators, pneumatic actuators, and electro-mechanical actuators.

4. The unit of claim 1, wherein the fluid source is a reservoir provided in the wall.

5. The unit of claim 1, wherein the fluid source is a portable reservoir.

6. The unit of claim 1, further including an electrical outlet integrated with the body, the electrical outlet electrically connectable to an electric power source.

7. The unit of claim 1, including a video monitor connected with the body.

8. The unit of claim 7, wherein the video monitor is moveably connected to a bottom surface of the lid.

9. The unit of claim 8, wherein the video monitor is moveable between a closed position and an open position.

10. The unit of claim 1, further including a satellite dish.

11. The unit of claim 10, wherein the satellite dish is connected to a top surface of the lid.

12. The unit of claim 10, including a video monitor connected with the body.

13. The unit of claim 12, wherein the video monitor is moveably connected to a bottom surface of the lid.

14. The unit of claim 12, wherein the video monitor is moveable between a closed position and an open position.

15. A portable unit comprising:
a body having a bottom panel, a wall extending upward from the bottom panel and surrounding at least a portion of the bottom panel to define an interior area;
a lid moveably connected with the body, the lid moveable between an open position and a closed position; and
a video monitor connected with the lid, the video monitor moveable between an open and a closed position.

16. The unit of claim 15, wherein the video monitor is oriented substantially parallel to the lid when it is in its closed position.

17. The unit of claim 15, further including a satellite dish functionally connected to the video monitor.

18. The unit of claim 15, wherein the video monitor is a flat panel television.

19. A method for removing a tailgating unit from a vehicle, the method comprising the steps of:
positioning a rack above a tailgating unit that is positioned on the vehicle, the tailgating unit comprising a body having a bottom panel, a wall extending up from the bottom panel and surrounding at least a portion of the bottom panel, and a lid member moveably connected to the body between an open and a closed position;
tethering the open lid to a rack positioned above the tailgating unit; and
actuating the lid from the open position to the closed position causing the body to be raised to the lid and away from the vehicle.

20. The method of claim 19, wherein the vehicle is a pickup truck.
